(19) United States
(12) Patent Application Publication
(10) Pub. No.: US 2007/0295315 A1
(43) Pub. Date: Dec. 27, 2007

(54) Oil Separator for Internal Combustion Engine

(76) Inventors: Pascal Guerry, Seppois le Bas (FR); Richard Emmanuel, Moirans en Montagne (FR); Herve Martinengo, Chilly (FR); Hippolyte Mounier, Bellegarde sur Valserine (FR); Anthony Nollevaux, Billiat (FR); Emmanuel Aubry, Montanges (FR); Sonia Elfakir, Bellegarde sur Valserine (FR)

Correspondence Address: OLIFF & BERRIDGE, PLC, P.O. BOX 320850, ALEXANDRIA, VA, 22320-4850, US

(21) Appl. No.: 11/660,946

(22) PCT Filed: Aug. 26, 2005
(86) PCT No.: PCT/FR05/02153

§ 371 Date: May 1, 2007

(30) Foreign Application Priority Data
Aug. 27, 2004 (FR) 0409154

(51) Int. Cl. B01D 12/00

(52) U.S. Cl. 123/572

(57) ABSTRACT

The inventive oil separator provided for de-oiling a gas exhausted from a crankshaft case (1) comprises oil collecting means (11) associated with a siphon (12) whose inlet inside the oil separator (7) is encompassed by an oil recovery chamber (13) provided with a perforated wall, at least a small oil recovery hole (14) arranged in the lowest part of the chamber (13) at the exit of the collecting means (11) and at least one depressurising small hole (15) which is arranged in the highest part of the chamber (13) above a clarified oil surface and is connected to the chamber (13) at a depressurising point (16). Said invention is usable for internal combustion engines.

The present invention relates in a general manner to the field of internal combustion engines and concerns more particularly an oil separator provided for de-oiling gases leaving a crankcase.

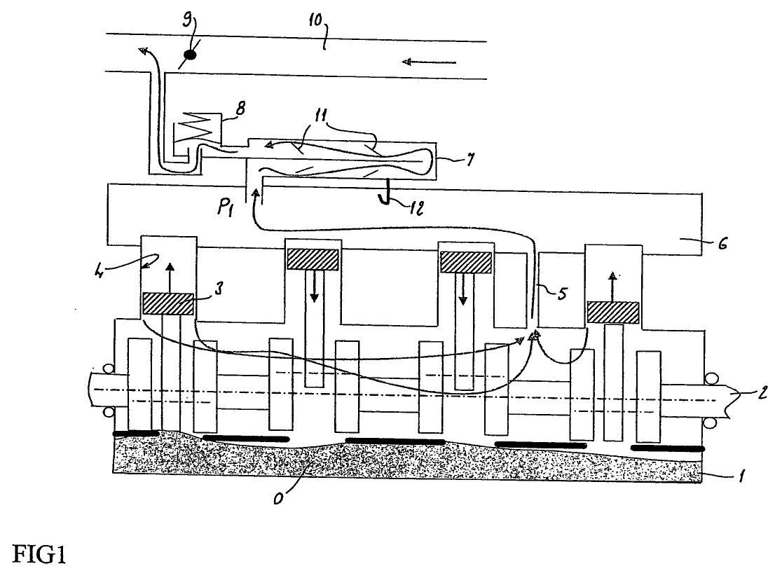

FIG. 1 of the appended schematic drawings shows schematically, in longitudinal section, a portion of an internal combustion engine according to the prior art, for the purpose of explaining the problem that is the basis of the present invention.

As illustrated in FIG. 1, a case 1 contains a crank 2 that cooperates with pistons 3 sliding in cylinders 4. The crank 2 is lubricated with a lubricating oil 0. Ducts S connect the case 1 to a cylinder head 6.

The cylinder head 6 leads to an oil separator 7 provided for de-oiling gases a from the crankcase, coming from leakages between the pistons 4 and the cylinders 3, and which are filled with lubricating oil droplets 0 in the crankcase 1.

To this end, the oil separator 7 comprises means 11 for trapping oil, associated with a siphon 12. The trapping means are for example separators with obstacles 11 such as baffles, blades, elbows, etc.

Inside the oil separator 7, the oil droplets 0 have different trajectories from those of gas particles that are less dense than oil, and so are retained by the separators 11.

The droplets 0 flow out to accumulate at the bottom of the oil separator 7. The oil recovered in this way then returns to the cylinder head 6 via the siphon 12, while the de-oiled gases' rejoin an air intake line 10, first of all passing through a valve 8 and through a butterfly valve 9. The valve 8 closes when the pressure drop after the butterfly valve 9 is large.

The siphon 12 ensures the presence of a sufficient oil reserve at the bottom of the oil separator 7, which prevents non-separated gases G from entering the circuit by compensating for the pressure reduction (P1-P2) between the inlet of the oil separator 7 at pressure P1 and the position of the siphon 12 at pressure P2.

The pressures in the case gas circuit vary according to the pressure waves created by the inlet valves and the movement of the pistons 3 in the cylinders 4. When pressure reductions are sufficiently high, the siphon 12 can fail to prime, that is to say, gas passes through the siphon 12 in the form of bubbles. This failure to prime can also be produced under the effect of phenomena that are difficult to controls engine vibrations or the effect of vehicle acceleration bringing about disruption of the oil level, etc.

Disruption of the siphon 12 will produce gas bubbles that will burst in the region of the decanting surface of the oil reserve, creating oil droplets. By their speed, the gases above the decanting surface carry these oil droplets over to the air intake line 10. This phenomenon of oil carry-over is also produced at the moment the siphon 12 primes.

The object of the present invention is to prevent the aforementioned disadvantages by providing an oil separator of which the siphon is more stable and less sensitive to pressure reductions.

To this end, the subject of the invention is an oil separator for an internal combustion engine, provided for de-oiling gases leaving a case of a crank, and essentially comprising means for trapping oil associated with a siphon of which the inlet inside the oil separator is surrounded by an oil recovery chamber of which the wall is drilled:
with at least one small oil recovery hole provided at the lowest point of the chamber leaving the trapping means, and
with at least one small depressurizing hole, provided at the highest point of the chamber above the surface of the recovered oil, and which connects the chamber to a point under reduced pressure.

The fact of isolating the inlet of the siphon by a buffer volume, communicating with the main stream by small holes, makes it possible to damp the pressure pulses that can be observed in the main stream of the crankcase gas circuit.

When the siphon is disrupted, the air flow passing above the pool of oil is limited by the diameter of the holes of the chamber, and there is therefore little direct carry-over of oil to the air intake. There is little risk of droplets that may be projected passing through the depressurizing hole which is small.

Moreover, the free surface of the siphon can exceed the height of the oil recovery hole without the risk of oil being carried over to the air intake. Since the depressurizing hole between the chamber and the main stream is arranged to be as high as possible, the oil can fill the chamber in the case of a large pressure reduction, which is in particular the case when the trapping means are effective and create considerable pressure losses.

According to one possible embodiment, the point under reduced pressure is made in the form of a Venturi tube. The Venturi tube has the advantage, compared with a pressure tap downstream of the outflow (therefore under reduced pressure), of creating a source of pressure reduction without requiring a great length of conduit.

Moreover, the rate of aspiration through the Venturi is proportional to the flow passing in the decanter, so that maximum aspiration is obtained in the operating phase which requires it. With a pressure tap downstream of the line, this coordination in time does not exist so that the aspiration flow rate can be high in an operating phase where the decantation flow rate is low.

In this context, the wall of the recovery chamber can be drilled with a second oil aspiration hole provided at the lowest point of the chamber downstream of the Venturi tube. This arrangement makes it possible to aspirate the recovered oil completely even in exceptional operating phases of the vehicle, in particular high accelerations on inclined roads, in which all the oil is not separated.

In order to reinforce this phenomenon, the Venturi tube is advantageously elbowed downstream so that the downstream end of the Venturi tube emerges close to the second oil aspiration hole. The elbow leaving the Venturi tube, will increase the supply pressure to the second aspiration hole.

Advantageously, in order to optimize the stability of the siphon, the volume of the part of the siphon at the pressure of the chamber is approximately three times less than the volume of the part of the siphon at the crankcase pressure.

In any event, the invention will be better understood with the aid of the following description, with reference to the appended schematic drawings, showing a preferred embodiment of an oil separator according to the invention, in which drawings:

FIG. 1 (already mentioned) is a schematic view in longitudinal section of a portion of an internal combustion engine according to the prior arts

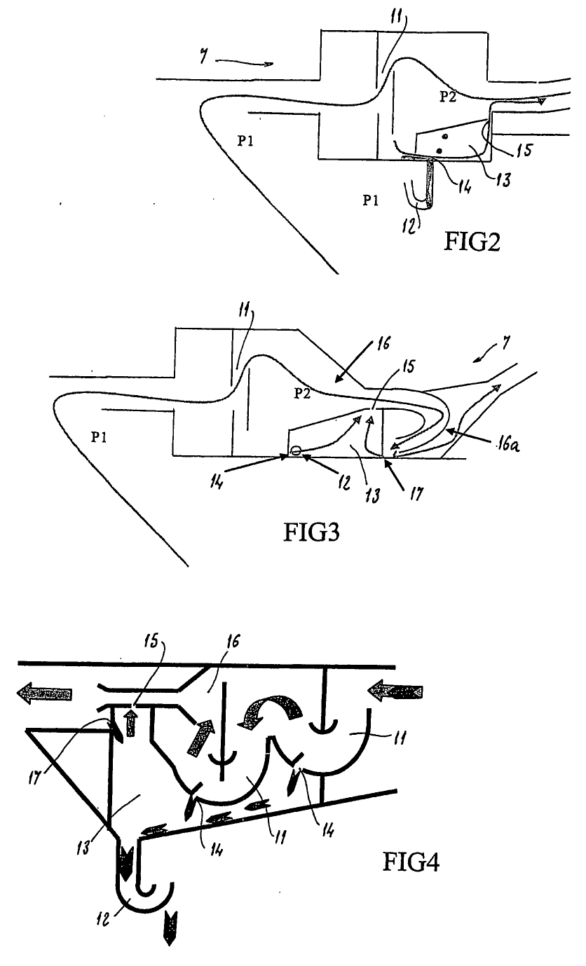

FIG. 2 is a schematic view of an oil separator according to a first embodiment of the invention;

FIG. 3 is a schematic view of an oil separator according to a second embodiment of the invention;

FIG. 4 is a sectional view of an embodiment of the oil separator similar to FIG. 3.

The structural elements shown in FIGS. 2, 3 and 4 which correspond to those previously described with reference to FIG. 1 are indicated by the same numerical references and will not be described again.

According to the invention, and as shown in FIG. 2, the inlet of the siphon 12 inside the oil separator 7 is surrounded by an oil recovery chamber 13.

The chamber 13 isolates the inlet of the siphon 12 and makes it possible to damp the pulses of the pressure Pl in the main stream.

The wall of the chamber 13 is drilled with a small oil recovery hole 14, provided at the lowest point of the chamber 13 leaving the separators with obstacles 11.

A small depressurizing hole 15 is also provided at the highest point of the chamber 13, above the decanting surface of the recovered oil. The hole 15 connects the chamber 13 to a point under reduced pressure 16.

When the siphon 12 is disrupted, the air flow passing above the pool of oil is limited by the diameter of the holes 14 and 15. There is therefore little direct carry-over of oil to the air intake 10. There is little risk of oil droplets that may be projected passing through the depressurizing hole 15 since this is small.

The depressurizing hole 15 is provided at the highest possible point in the chamber 13. Thus, in the case of a large pressure reduction, the oil level can fill the chamber 13 beyond the height of the oil recovery hole 14 without the risk of oil being carried over to the air intake 10.

It V1 and V2 indicate the volumes of the siphon 12, at the pressure P1 of the crankcase 1 and the pressure P2 of the chamber 13 respectively, various tests carried out by the Applicant have led to the following ratio of volumes between the various parts of the siphon 12: V1=3×V2, This ratio makes it possible to reduce the risks of disruption of the siphon 12.

In the embodiment illustrated in FIG. 3, the depressurizing point is made in the form of a Venturi tube 16.

It is important in point of fact to create a pressure reduction in the chamber 13 in order to be able to aspirate the oil correctly. In order to achieve this aspiration, the Venturi tube 16 is more advantageous than a pressure tap downstream to the flow, since a great length of pipe is not required to create the pressure reduction.

The wall of the chamber 13 is also drilled with a second oil aspiration hole 17 provided at the lowest point of the chamber 13 downstream of the Venturi tube 16. This arrangement makes it possible to aspirate the recovered oil completely even in exceptional operating phases of the vehicle, in particular high acceleration on inclined roads, during which all the oil is not separated.

The Venturi tube 16 has an elbow 16a downstream so that the downstream end of the Venturi tube 16 emerges close to the second oil aspiration hole 17, The elbow 16a will increase the supply pressure to the second aspiration hole 17.

As shown in FIG. 4, separators with obstacles can be made in the form of successive elbows 11.

As is evident, the invention is not limited to only the forms of implementation described above as nonlimiting examples, but on the contrary it encompasses all variants. There will be no departure in particular from the scope of the invention if the trapping means, here made in the form of separators with obstacles, are replaced by cyclone separators or separators with filter media.

1. An oil separator for an internal combustion engine, provided for de-oiling gases leaving a case of a crank, and comprising means for trapping oil associated with a siphon, wherein the inlet of the siphon inside the oil separator is surrounded by an oil recovery chamber of which the wall is drilled:
with at least one small oil recovery hole provided at the lowest point of the chamber leaving the trapping means, and
with at least one small depressurizing hole provided at the highest point of the chamber above the surface of the decanted oil, and which connects the chamber to a point under reduced pressure.

2. The oil separator as claimed in claim 1, wherein the point under reduced pressure is made in the form of a Venturi tube.

3. The oil separator as claimed in claim 2, wherein the wall of the recovery chamber+3 is drilled with a second oil aspiration hole provided at the lowest point of the chamber downstream of the Venturi tube.

4. The oil separator as claimed in claim 3, wherein the Venturi tubed is elbowed downstream so that its downstream end emerges close to the second oil aspiration hole.

5. The oil separator as claimed in claim 1, wherein the volume of the part of the siphon at the pressure of the chamber is approximately three times lower than the volume of the part of the siphon at the pressure of the case.

6. The oil separator as claimed in claim 2, wherein the volume of the part of the siphon at the pressure of the chamber is approximately three times lower than the volume of the part of the siphon at the pressure of the case.

7. The oil separator as claimed in claim 3, wherein the volume of the part of the siphon at the pressure of the chamber is approximately three times lower than the volume of the part of the siphon at the pressure of the case.

8. The oil separator as claimed in claim 4, wherein the volume of the part of the siphon at the pressure of the chamber is approximately three times lower than the volume of the part of the siphon at the pressure of the case.
